(19) United States
(12) Patent Application Publication
(10) Pub. No.: US 2025/0058152 A1
(43) Pub. Date: Feb. 20, 2025

(54) TOOL FOR CUTTING SHEET METAL

(71) Applicant: Clint Stefan Buchko, London (CA)

(72) Inventor: Clint Stefan Buchko, London (CA)

(21) Appl. No.: 18/808,520

(22) Filed: Aug. 19, 2024

Related U.S. Application Data
(60) Provisional application No. 63/533,691, filed on Aug. 20, 2023.

(51) Int. Cl. A62B 3/00; B23D 29/02

(52) U.S. Cl. CPC A62B 3/005; B23D 29/026

(57) ABSTRACT

A tool for cutting sheet metal, the tool comprising a shaft, a cutting blade, a blade holder coupled to a top end of the shaft and configured to retain the cutting blade. A handle is coupled to the bottom end of the shaft, opposite the blade holder. A sliding hammer including a through hole configured to engage the shaft is provided between the handle and blade holder. The tool may be used as an axe, wherein the cutting blade may be swung by a user to penetrate sheet metal. The slide hammer may be configured to slide manually up and down the shaft, striking components on either side of the tool and generating an impact force that facilitates cutting of sheet metal by the cutting blade. The tool may be used to open extraction points in a vehicle for first responders after a vehicular collision.

### BACKGROUND

The present disclosure relates generally to tools for cutting sheet metal, and more specifically, to rescue equipment for cutting sheet metal on vehicles for gaining access to a vehicle interior.

Rescue devices are crucial for first responders because they enable quick and efficient access to victims in emergency situations, such as natural disasters, accidents, or building collapses. These devices help save lives by allowing responders to reach and extricate individuals who are trapped or in danger. Manual rescue devices are often preferred over powered ones because they are more reliable in unpredictable conditions. Unlike powered devices, which may fail due to battery depletion, mechanical issues, or lack of power sources, manual tools are simpler, less prone to malfunction, and can be operated under any circumstances, ensuring that responders can act swiftly and effectively when every second counts.

In a crisis such as a near fatal collision, the sheet metal body of a vehicle may need to be cut in order to extract a victim, and the ability to do so quickly may make the difference between life and death. As such, there is a need for an improved system for quickly cutting sheet metal with increased reliability and without the need for a power source.

### SUMMARY

According to various embodiments, disclosed is a system and tool for cutting sheet metal, the tool comprising a shaft; a cutting blade; an adapter coupled to a bottom end of the shaft and configured to retain the blade; a handle coupled to the top end of the shaft, opposite the blade holder adapter; and a sliding hammer including a through hole configured to engage the shaft, provided between the handle and blade holder adapter. In certain embodiments, the tool may be used as an axe, wherein the blade acts as the axe head to penetrate sheet metal when the tool is swung. The hammer is further configured to slide manually up and down the shaft, striking stopping plates to cause the blade to cut the sheet metal lengthwise. The tool may be used to open extraction points in a vehicle for first responders after a heavy collision.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a tool for cutting sheet metal according to an embodiment of the invention;

FIG. 2 depicts a tool for cutting sheet metal according to an alternative embodiment of the invention;

FIG. 3 depicts a shaft, handle, and slide hammer of a tool for cutting sheet metal according to an embodiment of the invention; and

FIG. 4 depicts a rear side of a blade holder, a front side of a blade holder, and a cutting blade of a tool for cutting sheet metal according to an embodiment of the invention.

### DETAILED DESCRIPTION OF CERTAIN EMBODIMENTS

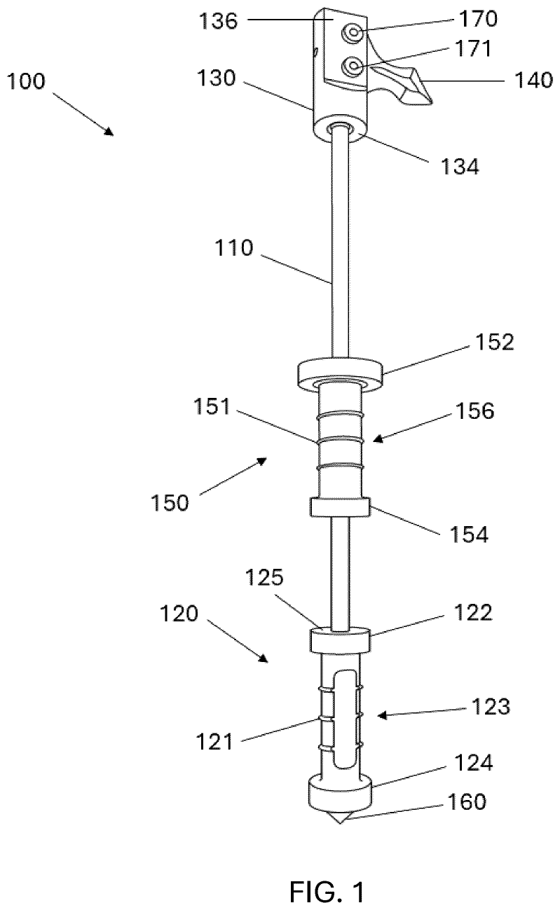

According to various embodiments as depicted in FIGS. 1-4 disclosed is a system and tool for cutting sheet metal, the tool comprising a shaft; a cutting blade; an adapter (also referred to as a “blade holder adapter”) coupled to a bottom end of the shaft and configured to retain the blade; a handle coupled to the top end of the shaft, opposite the blade holder adapter; and a sliding hammer including a through hole configured to engage the shaft, provided between the handle and blade holder adapter.

As depicted in FIG. 1, an embodiment of the tool 100 includes a shaft 110 having a top end 112 and a bottom end 114. A handle 120 is attached to the bottom end 114 of the shaft 110. The handle 120 has a bottom side 124 and a top side 122. A blade holder 130 is attached to the top end 112 of the shaft 110, the blade holder 130 is configured to receive a cutting blade 140. The tool 100 further includes a slide hammer 150 having a bottom side 154, a top side 152, and a through hole 156 extending from the bottom side 154 of the slide hammer 150 to the top side 152 of the slide hammer 150. The slide hammer 150 is configured to slide along the shaft 110 between the top side 122 of the handle 120 and a bottom side 134 of the blade holder 130.

In an embodiment, the handle 120 is cylindrical and includes protrusions 121 configured to facilitate a user's grip of the tool 100. The bottom side 124 of the handle 120 may extend radially beyond a middle portion 123 of the handle 120. The bottom side 124 of the handle 120 may further include a conical tip 160 facing outward from the bottom side 124 of the handle 120. Further, the top side 122 of the handle 120 may extend radially beyond the middle portion 123 of the handle 120 and the top side 122 of the handle 120 including a first striking surface 125.

In an embodiment, the blade holder 130 is cylindrical and includes a mounting face 136. The cutting blade 140 may be configured to extend radially from the blade holder 130 with the cutting blade 140 having at least one cutting edge 141, 142 and a cutting tip 143. The cutting blade 140 may be configured to extend radially from the blade holder 130 when received by the blade holder 130. The cutting blade 140 is configured to be affixed to the blade holder 130 by at least one fastener 170, 171. The fastener 170, 171 may be a bolt, a screw, a rivet, or another fastener suited to firmly attach the cutting blade 140 to the blade holder 130.

In an embodiment, the slide hammer 150 may be cylindrical and include protrusions 151 configured to facilitate a user's grip of the slide hammer 150. The bottom side 154 of the slide hammer 150 is a second striking surface and the top side 152 of the slide hammer 150 is a third striking surface. In certain embodiments, the third striking surface may be radially wider than the second striking surface. The slide hammer 150 may be configured to slide along the shaft 110 such that the second striking surface of the slide hammer 150 strikes the first striking surface of the handle 120 and the third striking surface of the slide hammer 150 strikes the bottom side 134 of the blade holder 130.

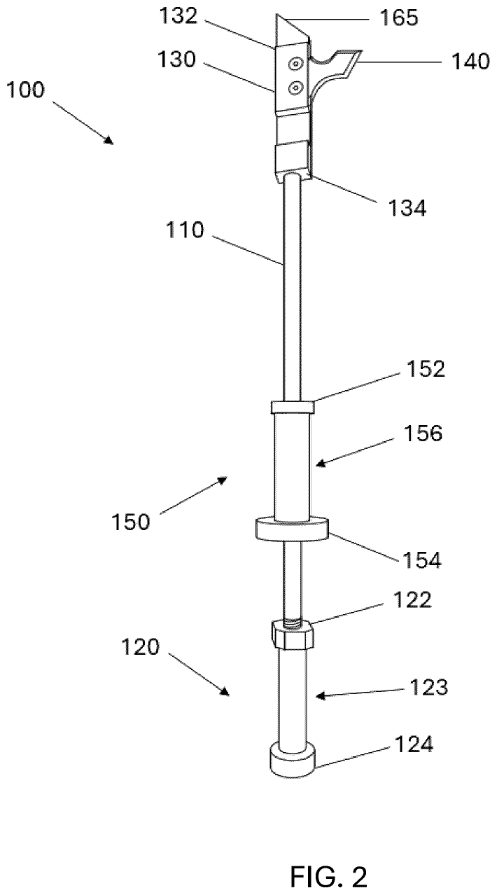

As depicted in FIG. 2, an embodiment of the tool 100 may include an impact wedge 165 on a top side 132 of the blade holder 130 instead of the conical tip 160 on the bottom side 124 of the handle 120 as shown in FIG. 1. In addition, as shown in FIG. 2, alternative embodiments of the tool 100 may include a blade holder 130 with a square shape instead of the cylindrical shape shown in FIG. 1.

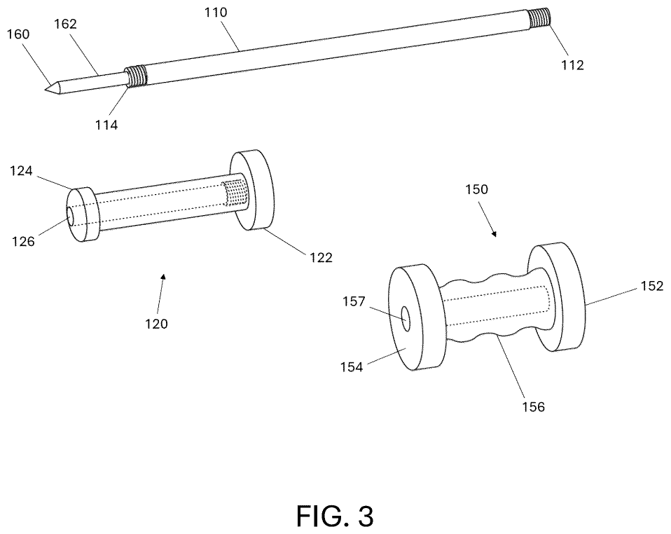

In certain embodiments, the shaft 110 may be about 1 inch in diameter, and about 3 feet long, but is not limited to these options. The shaft 110 may include threading on the top end 112 and the bottom end 114 to receive and fasten onto the blade holder 130 and the handle 120, respectively. As shown in FIG. 3, the conical tip 160 may be affixed to the bottom end 114 of the shaft 110 via a rod 162 which passes through a through-hole 126 in the handle 120. In this embodiment, the handle 120 would be attached to the shaft 110 by inserting the conical tip 160 through the through-hole 126 of the handle and then twisting the handle 120 to thread the handle 120 onto threading on the bottom end 114 of the shaft 110. As such, the conical tip 160 would protrude from the bottom side 124 of the handle 120 when the handle 120 is firmly attached. Also, as shown in FIG. 3, the slide hammer 150 has a through-hole 157 configured to slide along the portion of the shaft 110 between the top end 112 and the bottom end 114. In another embodiment, the conical tip 160 is formed into the bottom side 124 of the handle 120 such that the conical tip 160 is affixed to the handle 120 instead of the shaft 110.

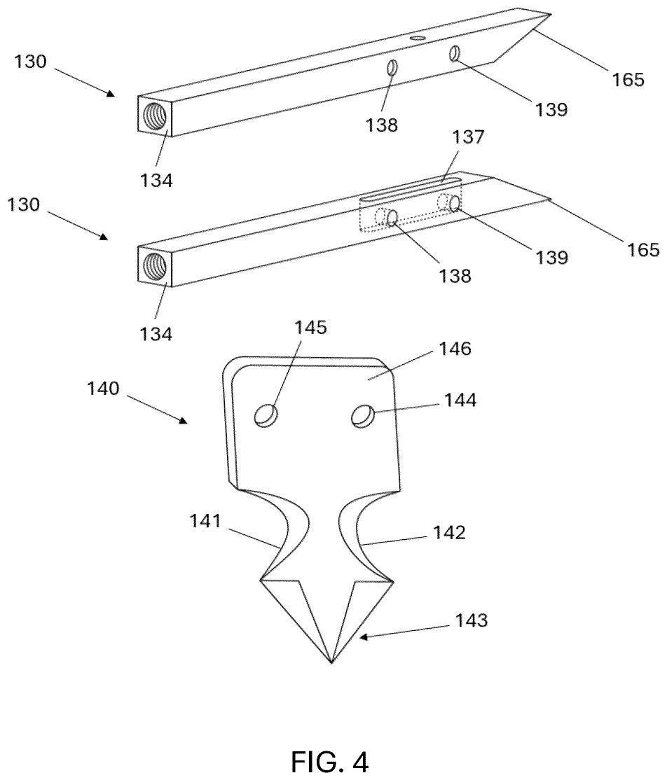

In FIG. 4, the blade holder 130 with a square shape is depicted along with a cutting blade 140. The blade holder 130 may have threading on the bottom side 134 to receive and attach to threading on the top end 112 of the shaft 110. A blade slot 137 may extend from a side of the blade holder 130 to receive the cutting blade 140. Fasteners 170, 171 may be inserted and threaded into holes 138, 139 of the blade holder 130 and pass through holes 144, 145 of the cutting blade 140 to affix the cutting blade 140 to the blade holder 130. The cutting blade 140 may include a cutting tip 143 and at least one cutting edge 141, 142. In certain embodiments, such as the embodiment depicted in FIG. 1, the blade holder may have a cylindrical shape and a mounting face 136 to receive the fasteners 170, 171 instead of the configuration of the blade holder 130 shown in FIG. 4.

As mentioned above, the cutting blade 140 may be a removable and replaceable component of the tool 100. In some embodiments, the cutting blade 140 may be made of tooling steel. The cutting blade 140 may include a bracket extension 146 configured to insert into the blade slot 137 of the blade holder 130, wherein the bracket extension 146 may be secured to the blade holder 130 via the fasteners 170, 171 engaged through correspondingly aligned holes 138, 139. In a further embodiment, the blade slot 137 may continuously extend to an opposite side of the blade holder 130 to enable a user to push out the cutting blade 140 from the blade slot 137 by pushing on the cutting blade 140 from the opposite side of the cutting tip 143.

In an embodiment, the handle 120 may have an indexable grip section 123 between the bottom side 124 and the top side 122. In one embodiment, the top side 152 of the slide hammer 150 may be larger than the bottom side 154 of the slide hammer 150 to facilitate grip. In certain embodiments, the disclosed tool 100 may be used for cutting sheet metal by first using the tool 100 as an axe. This may comprise swinging the tool 100 so that the cutting blade 140 penetrates sheet metal. Once penetrated, the slide hammer 150 may be slid up and down the shaft 110 by the user such that the second striking surface of the slide hammer 150 strikes the first striking surface of the handle 120 and the third striking surface of the slide hammer 150 strikes the bottom side 134 of the blade holder 130. The impact force generated by the slide hammer 150 striking these surfaces transfers to the cutting blade 140, and specifically to the at least one cutting edge 141, 142 thereby facilitating cutting of the penetrated sheet metal.

The disclosed tool 100 may be used to cut through the sheet metal on the roofs of vehicles to open an exit/entry point for victims and first responders. The tool 100 may also be used for opening door skins on vehicles for access to latch mechanisms in damaged doors. The tool 100 may further be used to cut out windshields and break tempered glass for extraction of a victim. The tool 100 only requires one person to operate and does not require hydraulic, electric, or air power. It can be easily wielded and operated with no set up time. As such, first responders to a vehicle collision may begin extraction and/or first quickly and expeditiously.

It shall be appreciated that the disclosed device may be manufactured and assembled using any known techniques in the field. In certain embodiments, a CNC machine may be used to cut the cutting blades 140. The cutting blade 140 may be machined on a vertical mill out of cold rolled steel. The shaft 110, handle 120, blade holder 130, and slide hammer 150 may all be turned on a lathe.

It shall be appreciated that the disclosed device and system can have multiple configurations in different embodiments. In certain embodiments, the cutting blade 140 could be removed and replaced with a standard dent pulling attachment. In certain embodiments, the disclosed tool 100 may also be adapted for other uses. For example, heavy collision auto body technicians could use the tool to remove damaged sheet metal. It shall be appreciated that the device described herein may comprise any alternative known materials in the field and be of any size and/or dimensions.

It shall be understood that the orientation or positional relationship indicated by terms such as “upper”, “lower”, “front”, “rear”, “left”, “right”, “top”, “bottom”, “inside”, “outside” is based on the orientation or positional relationship shown in the accompanying drawings, which is only for convenience and simplification of describing the disclosed subject matter, rather than indicating or implying that the indicated device or element must have a specific orientation or are constructed and operated in a specific orientation, and therefore should not be construed as a limitation of the present invention.

As used herein, the articles “a” and “an” are intended to include one or more items and may be used interchangeably with “one or more.” Where only one item is intended, the term “one” or similar language is used. Also, as used herein, the terms “has”, “have”, “having”, “with” or the like are intended to be open-ended terms. Further, the phrase “based on” is intended to mean “based, at least in part, on” unless explicitly stated otherwise.

The constituent elements of the disclosed device and system listed herein are intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device. Terms such as ‘approximate,’ ‘approximately,’ ‘about,’ etc., as used herein indicate a deviation of within +/−10%. Relationships between the various elements of the disclosed device as described herein are presented as illustrative examples only, and not intended to limit the scope or nature of the relationships between the various elements.

What is claimed is:

1. A tool comprising:
a shaft having a top end and a bottom end;
a handle attached to the bottom end of the shaft, the handle having a bottom side and a top side;
a blade holder attached to the top end of the shaft, the blade holder being configured to receive a cutting blade;
a slide hammer having a bottom side, a top side, and a through hole extending from the bottom side of the slide hammer to the top side of the slide hammer, the slide hammer being configured to slide along the shaft between the top side of the handle and a bottom side of the blade holder.

2. The tool of claim 1, wherein the handle is cylindrical and includes protrusions configured to facilitate a user's grip of the tool.

3. The tool of claim 2, wherein the bottom side of the handle extends radially beyond a middle portion of the handle, the bottom side of the handle including a conical tip facing outward from the bottom side of the handle.

4. The tool of claim 2, wherein the top side of the handle extends radially beyond a middle portion of the handle, the top side of the handle including a first striking surface.

5. The tool of claim 1, wherein the blade holder is cylindrical and includes a mounting face.

6. The tool of claim 1, wherein the cutting blade is configured to extend radially from the blade holder, the cutting blade having at least one cutting edge and a cutting tip.

7. The tool of claim 6, wherein the cutting blade is configured to extend radially from the blade holder when received by the blade holder.

8. The tool of claim 6, wherein the cutting blade is configured to be affixed to the blade holder by at least one fastener.

9. The tool of claim 8, wherein the at least one fastener is a nut and bolt.

10. The tool of claim 4, wherein the slide hammer is cylindrical and includes protrusions configured to facilitate a user's grip of the slide hammer.

11. The tool of claim 10, wherein the bottom side of the slide hammer is a second striking surface.

12. The tool of claim 11, wherein the top side of the slide hammer is a third striking surface.

13. The tool of claim 12, wherein the third striking surface is radially wider than the second striking surface.

14. The tool of claim 10, wherein the slide hammer is configured to slide along the shaft such that the second striking surface of the slide hammer strikes the first striking surface of the handle and the third striking surface of the slide hammer strikes the bottom side of the blade holder.
